(19) United States
(12) Patent Application Publication
(10) Pub. No.: US 2016/0105779 A1
(43) Pub. Date: Apr. 14, 2016

(54) SYSTEMS AND METHODS FOR TRANSMITTING VEHICLE DATA VIA MULTIMEDIA MESSAGING SERVICE (MMS) PROTOCOL

(71) Applicant: Laird Technologies, Inc., Earth City, MO (US)

(72) Inventor: Jason Stoddard, Gaines, MI (US)

(21) Appl. No.: 14/510,993

(22) Filed: Oct. 9, 2014

(51) Int. Cl. H04W 4/12; H04L 29/06

(52) U.S. Cl. CPC H04W 4/12; H04L 67/42

(57) ABSTRACT

A computer-implemented method of transmitting data via a network from a client device to a computer server includes collecting data from one or more sensors in or about a vehicle, generating an image representing the collected data, and transmitting the image to a computer server via multimedia messaging service (MMS) protocol. In other exemplary embodiments, a computer-implemented method of receiving data from one or more client devices includes transmitting a request for data to a client device of the one or more client devices via MMS protocol, receiving an image representing data collected by the client device via MMS protocol in response to the request, and decoding the image to reveal the collected data. Example embodiments of client devices, computer servers, and non-transitory computer readable medium for storing computer-executable instructions for performing one or more of the example methods are also disclosed.

### FIELD

The present disclosure relates to systems and methods for transmitting vehicle data via multimedia messaging service (MMS) protocol.

### BACKGROUND

This section provides background information related to the present disclosure which is not necessarily prior art.

Fleet management systems typically include various vehicle tracking devices in communication with a central computer. These vehicle tracking devices may send data messages to the central computer using Global System for Mobile Communications (GSM) networks, while also using Short Message Service (SMS) protocols. The vehicle tracking devices can be customized to provide alerts in real-time

### SUMMARY

This section provides a general summary of the disclosure, and is not a comprehensive disclosure of its full scope or all of its features.

According to various aspects, exemplary embodiments of computer-implemented methods are disclosed. In an exemplary embodiment, a computer-implemented method of transmitting data via a network from a client device in a vehicle to a computer server includes collecting data from one or more sensors in or about a vehicle, generating an image representing the collected data, and transmitting the image to a computer server via multimedia messaging service (MMS) protocol.

In other exemplary embodiments, a computer-implemented method of receiving data from one or more client devices positioned in one or more vehicles is disclosed. The computer-implemented method is executed by one or more computer servers. The method includes transmitting a request for data to a client device of the one or more client devices via MMS protocol, receiving an image representing data collected by the client device via MMS protocol in response to the request, and decoding the image to reveal the collected data.

According to additional aspects of the present disclosure, exemplary embodiments of client devices, computer servers, and non-transitory computer readable medium storing computer-executable instructions for performing the computer-implemented methods are also disclosed.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flow chart of a computer-implemented method of transmitting data via a network from a client device to a computer server according to one example embodiment of the present disclosure.

FIG. 2 is a flow chart of a computer-implemented method of receiving data from one or more client devices according to another example embodiment.

FIG. 3 is a flow chart of a computer-implemented method of transmitting data from a client device to one or more computer servers according to yet another example embodiment.

FIG. 4 is a block diagram of a system including a client device and a computer server according to another example embodiment.

FIG. 5 is a diagram of a system including the computer server of FIG. 4 in communication with various client devices according to yet another example embodiment.

FIGS. 6A-6G are various example images representing data according to other example embodiments.

Corresponding reference numerals indicate corresponding parts throughout the several views of the drawings.

### DETAILED DESCRIPTION

Example embodiments will now be described more fully with reference to the accompanying drawings.

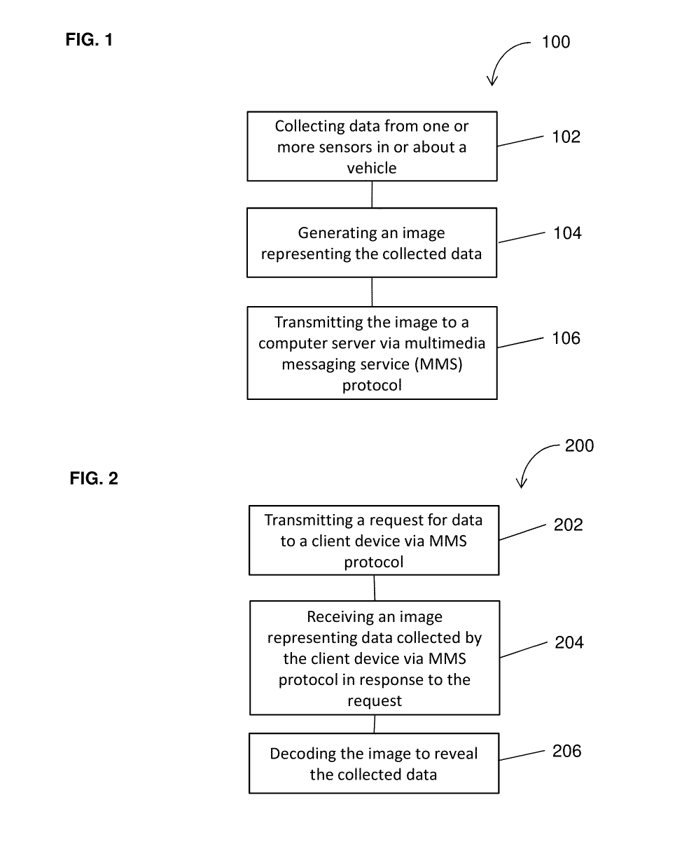

FIG. 1 illustrates a computer-implemented method 100 of transmitting data via a network from a client device in a vehicle to a computer server according to one example embodiment of the present disclosure. As shown in FIG. 1, the method 100 includes collecting data from one or more sensors in or about a vehicle in block 102, generating an image representing the collected data in block 104, and transmitting the image to a computer server via multimedia messaging service (MMS) protocol in block 106.

In some exemplary embodiments, the collected data may be encrypted prior to generating the image. For example, the collected data may include sensitive data such as confidential information, personal information, etc. Accordingly, the client device may include software application(s) to encrypt parts or all of the collected data. After the computer server receives and decodes the image, the computer server may decrypt the decoded image to reveal the collected data.

Additionally, the client device may receive a request for the data from the computer server via MMS protocol. The request for data may include a request for specific data not normally transmitted to the computer server, for data routinely collected, etc. In such exemplary embodiments, the client device may not collect data from the sensors until this request is received. In other exemplary embodiments, the client device may collect the data but wait to generate the image or transit the image until this request is received.

Alternatively, the client device may collect data, generate the image, and/or transmit the image (as explained above) without waiting for a request. For example, the client device may collect the data and/or generate the image in response to a defined event. As such, the client device may collect the data and/or generate the image after a period time (e.g., ten minutes, five days, 2 months, etc.) has elapsed. In other exemplary embodiments, the defined event may include another triggering event such as a signal received from a sensor indicating a collision, a specific distant traveled (e.g., a specific amount of miles, etc.), specific vehicle parameters (e.g., tire pressure, oil pressure, engine temperature, etc.), weather, geographic location, etc. Alternatively, the client device may collect the data, generate the image, and/or transmit the image randomly.

Further, the client device may receive a response from the computer server via MMS protocol in response to the transmitted image. For example, the client device may receive a response requesting additional data (e.g., specific data related to a particular feature of the vehicle, etc.), informing the client device of a particular condition (e.g., a condition of the vehicle, etc.), informing the client device of a warning (e.g., weather alerts, etc.), etc. The response may be received via another image (as explained herein), text, etc.

The client device may include one or more software applications for generating the image (e.g., sometimes referred to herein as an image generator). In such examples, the collected data, the encrypted data, etc. may be imported into the image generator where the image generator generates and outputs an image representing this collected data, encrypted data, etc. The image may then be transmitted as explained above, stored for a later transmission, etc. The image generator may automatically generate the image after receiving the collected data (e.g., operable without user input, etc.), wait to generate the image based on user commands, etc. Additionally and alternatively, the client device may generate the image representing the collected data in another suitable manner.

FIG. 2 illustrates another exemplary computer-implemented method 200 of receiving data from one or more client devices positioned in one or more vehicles. The computer-implemented method 200 is executed by one or more computer servers. The method 200 includes transmitting a request for data to a client device of the one or more client devices via MMS protocol in block 202, receiving an image representing data collected by the client device via MMS protocol in response to the request in block 204, and decoding the image to reveal the collected data in block 206.

In some exemplary embodiments, the computer server(s) may transmit the request when the client device becomes available. For example, if the client device is out of range, without cellular service, etc. during the computer server(s) “ask” operation, the computer server(s) may store the MMS message requesting data. Once the client device is available (e.g., within range, has cellular service, etc.), the “ask” can be propagated. Therefore, the MMS message requesting data may be transmitted to the client device.

In some examples, the computer server(s) may periodically, randomly, etc. determine if the client device is available. In other examples, the computer server(s) may be determined if the client device is available based on user command(s) or the like.

The computer server(s) may store the MMS message requesting data for any suitable period of time. For example, the computer server(s) may store the MMS message indefinitely, until the MMS message is sent, until the MMS message is cancelled, recalled, etc., for a defined period of time, etc.

The computer server(s) may transmit the request for data in response to a defined event. For example, the computer server(s) may transmit the request for data after a period time (e.g., ten minutes, five days, 2 months, etc.) has elapsed, and/or after another suitable triggering event such as a user command, a geographic location of the client device, programmed flags, etc. occurs. Alternatively and additionally, the computer server(s) may transmit the request for data randomly.

The computer server(s) may decode the image representing the collected data in any suitable manner. For example, the computer server(s) may include one or more software applications for decoding the image (e.g., sometimes referred to herein as an image decoder). In such examples, the received image may be imported into the image decoder where it decodes the image into the collected data, the encrypted data, etc. The image decoder may automatically decode the image (e.g., operable without user input, etc.), wait to decode the image based on user commands, etc.

After the image is decoded, the resulting collected data may be analyzed to determine if additional actions are needed. For example, the computer server(s) may transmit a response to the client device via MMS protocol in response to the analyzed data. In such examples, the computer server(s) may transmit a response requesting additional information (e.g., additional data, etc.), instructing the client device to output a message (e.g., via a display, a speaker, etc.), instructing the client device to control the vehicle in a particular manner (e.g., shut off the vehicle, change a particular route, change modes of operation, etc.). The response may be transmitted in response to a defined event (as explained above), immediately after analyzing the collected data, etc. Alternatively, the computer server(s) may transmit a response to the client device via MMS protocol in response to receiving the image and/or decoding the collected data (e.g., before analyzing the data, at the same time as analyzing the data, etc.).

In some examples, an image (as explained herein) may be generated to represent this response. In such cases, the client device would decode the image and proceed accordingly. Additionally and alternatively, the response may include text.

Additionally, the computer server(s) may store the collected data sent from the client device. For example, after the image is decoded to reveal the collected data, the computer server(s) may store at least a portion or all of the data in memory. Depending on the confidential nature of the collected data, the computer server(s) may store the collected data in its raw form (e.g., the actual collected data) and/or in an encrypted state (as explained above).

Additionally and/or alternatively, the computer server(s) may store the image sent from the client device representing the collected data. For example, the image representing the collected data may be stored as a JPG file, a PNG file, or another suitable file before and/or after decoding the data. The stored image may then be decoded (e.g., again or for the first time) to reveal the collected data when desired. In some exemplary embodiments, storing the image as compared to the collected data may save memory if the size (e.g., in kB, etc.) of the image is less than the collected data, may be easily archived, etc. Additionally, because the actual image is stored, the risk of losing data may be reduced as compared to, for example, storing portions or all of the collected data in its raw form and/or in an encrypted state.

This stored data and/or the stored image may be used to analyze the vehicle including the client device at a later time, to compare other stored, collected, etc. data from other vehicles, etc. In some exemplary embodiments, the data and/or the image may be stored for a period of time, until the data and/or image is no longer required, until a user deletes the data and/or the image, etc. For example, the period of time may depend on the data collected, its confidential nature, etc.

Alternatively, the image may be decoded, and then utilized and/or discarded without storing the collected data and/or the image.

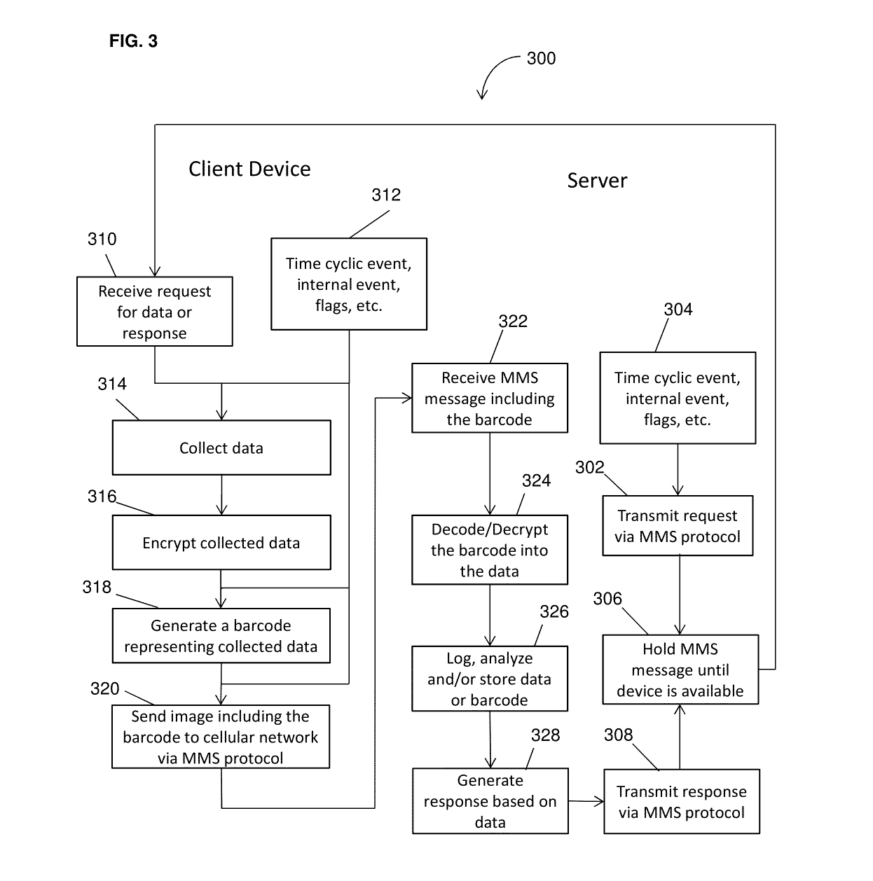

FIG. 3 illustrates yet another exemplary computer-implemented method 300 of transmitting data from a client device to one or more computer servers. As shown in FIG. 3, the method 300 may commence by transmitting a request from a server via MMS protocol in block 302. As shown in block 304, this request may be transmitted in response a defined event (e.g., a time cyclic event, an internal event, a flag, etc.) as explained above. The request may then be held until the client device is available in block 306.

After receiving the request for data (see block 310), the client device may collect data in block 314 and then encrypt the collected data in block 316 as explained above. Then, the client device may generate a barcode and/or another suitable image representing the collected data in block 318. After generating the barcode representing the collected data, the client device transmits the barcode to the server via a network (e.g., a cellular network, etc.) using MMS protocol as explained above in block 320.

Additionally and alternatively, the client device may proactively collect the data without receiving the request. For example, and as shown in block 312, the client device may begin collecting data in response to a defined event (e.g., a time cyclic event, an internal event, a flag, etc.) as explained above. Likewise, the barcode may be generated and/or transmitted to the server in response to a defined event.

After receiving the MMS message including the barcode in block 322, the server decodes the barcode and decrypts the encryption (if necessary) back into the collected data in block 324. As shown in block 326, the server may then take various actions with the collected data and/or the image. For example, the server may log the data, analyze the data, store the date and/or the image (as explained above).

If appropriate, the server may generate a response (see block 328) to send to the client device based on the received data and then transmit this to the client device via MMS protocol (in block 308). Similar to the original request, this response may be held until the client device is available in block 306.

After receiving the response (see block 310), the client device may proceed as explained above to collect additional data, instruct the client device to perform a particular function, etc.

In other exemplary embodiments, it is not necessary that each step shown in FIG. 3 be performed each time method 300 is performed. For example, the collected data may not be encrypted at all, partially encrypted, encrypted only when necessary, etc.

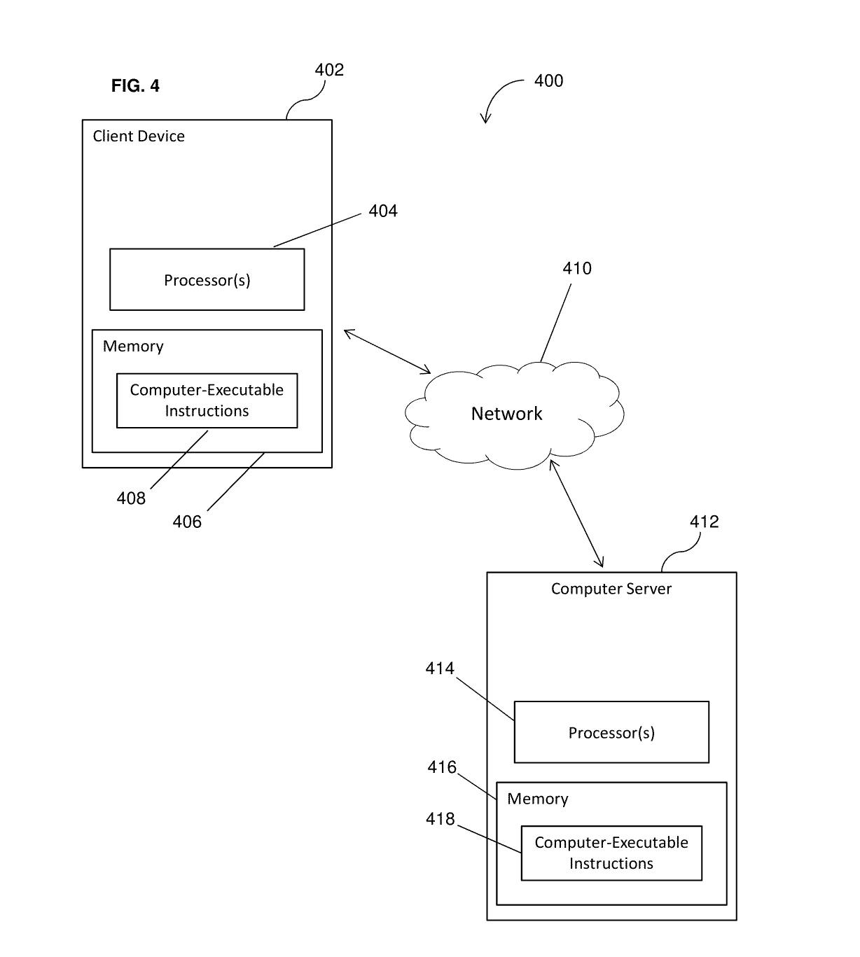

FIG. 4 illustrates an example system 400 including a client device 402 and a computer server 412. As shown in FIG. 4, the client device 402 includes one or more processors 404, memory 406, and computer-executable instructions 408. Likewise, the computer server 412 includes one or more processors 414, memory 416, and computer-executable instructions 418. The computer-executable instructions 408 and/or the computer-executable instructions 418 are operable to cause the processor(s) 404, 414 to perform one or more of the computer-implemented methods disclosed herein.

The client device 402 may be fixed to an interior portion of a vehicle and/or exterior portion of the vehicle. For example, the client device 402 may be attached to a dash, console, roof, etc. of the vehicle. Additionally and alternatively, the client device 402 may be modular such that it can be removed from one vehicle and placed in another vehicle if desired.

The computer executable instructions 408, 418 (e.g., program modules, etc.) may be executed by the processors 404, 414, respectively. Program modules may include routines, programs, objects, components, data structures, etc., that may perform particular tasks or implement particular abstract data types. The present disclosure may include a distributed computing environment where some processes may be performed by remote processing devices that may be linked through a communications network. Program modules may be located in local and/or remote computer storage mediums including memory storage devices.

The computer server 412 and/or the client device 402 may be implemented using a single processor, multiple processors on a single system, multiple processors across systems that may be in a local or distributed system, etc. The computer server 412 may include private servers and/or network computer server(s) (e.g., managed, supported, etc. by one or more cellular providers, etc.). For example, if the client device 402 is not available, the network computer server(s) may store the MMS message until the client device 402 is available as explained above.

The memory 406, 416 may be memory located on a single computer, a server, shared between multiple systems, etc. The memory 406, 416 may be located within the same system as one or more of the processors 404, 414 (including, e.g., onboard memory in the processors, etc.), or may be located externally. The memory 406, 416 may include volatile memory, nonvolatile memory, ROM, RAM, one or more hard disks, magnetic disk drives, optical disk drives, removable memory, non-removable memory, magnetic tape cassettes, flash memory cards, CD-ROM, DVDs, cloud storage, etc.

In addition to the memory 406, 416, the computer server 412 and/or the client device 402 may include and/or may be configured to receive one or more other non-transitory computer readable mediums. For example, the computer server 412 and/or the client device 402 may include a DVD player or the like to read DC-ROMs, DVDs, etc., USB port(s) or the like to receive flash memory, etc.

The computer executable instructions 408, 418 may be stored in any suitable location in the memory 406, 416 and may or may not be stored in the same memory. The instructions 408, 418 may be stored in memory 406, 416 on a single computer, a server, may be shared between multiple systems, etc. The memory 406, 416 and/or non-transitory computer readable medium may store the instructions 408, 418, operating systems, application programs, other program modules, program data, etc.

The client device 402 and the computer server 412 may communicate via network 410. For example, receiving/transmitting requests, responses, images, etc. may be passed via the network 410. The network 410 may include a cellular network, a local area network (LAN) (e.g., Intranet, etc.), a wide area network (WAN) (e.g., the Internet, etc.), etc. The network 410 may be a wired network and/or wireless network.

In some embodiments, the client device 402 may include one or more antennas and/or be in communication with one or more antennas external the client device 402 for sending and/or receiving communications to and/or from the computer server 412. For example, the client device 402 may include antenna(s) operating in the cellular frequency bands (e.g., about 698 MHz to about 960 MHz and from about 1710 MHz to about 2700 MHz, etc.), GPS antenna(s), etc. Likewise, the computer server 412 may include or be in communication with similar antenna(s).

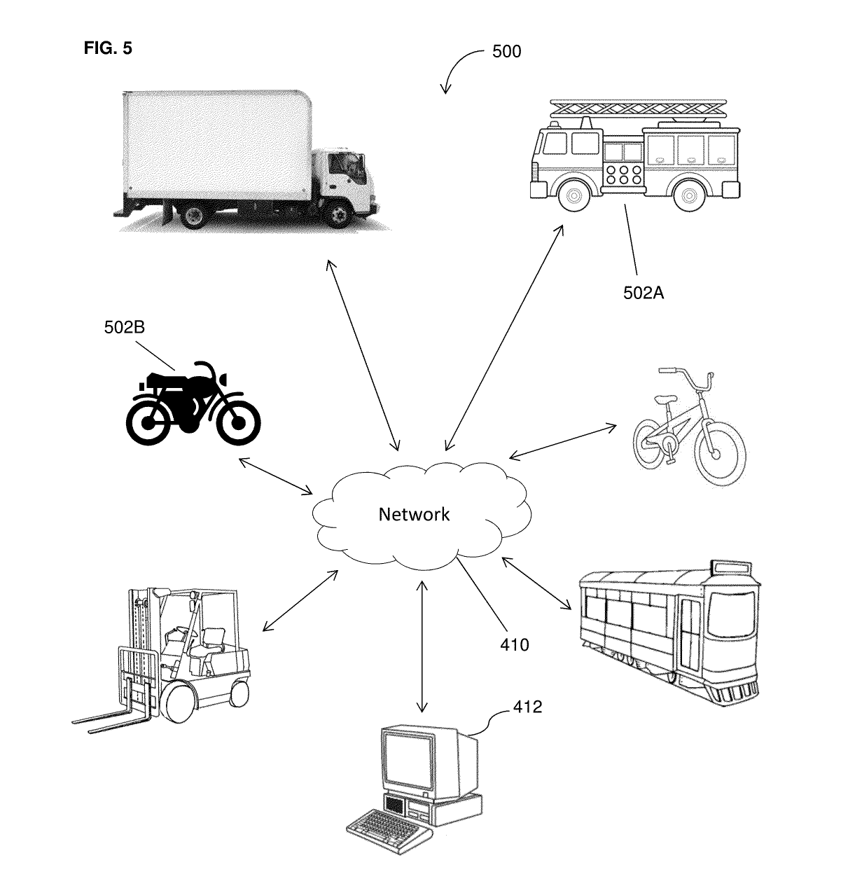

Although FIG. 4 illustrates one computer server 412 in communication with one client device 402, it should be apparent to those skilled in the art that a system may include more than one computer server in communication with more than one client device. For example, FIG. 5 illustrates an example system 500 including the computer server 412 of FIG. 4 in communication with various client devices (e.g., the client device 402 of FIG. 4 and/or similar devices, etc.) positioned on various vehicles (e.g., a fire truck 502A, a motorcycle 502B, etc.). Thus, the computer server 412 may transmit one or more requests for data, responses, etc. to different client devices via MMS protocol as explained herein. Additionally, the computer server 412 may receive one or more images representing the data from any one or more of the client devices positioned on the vehicles shown in FIG. 5.

The vehicles disclosed herein may be any suitable vehicle. For example, as shown in FIG. 5, the vehicles may include motorized vehicles such as vans, cars, emergency vehicles, motorcycles, forklifts, trains, boats, etc. and/or non-motorized vehicles such as bicycles, boats, etc.

The collected data disclosed herein may include any suitable data. For example, the collected data may include data relating to vehicle diagnostics, location, route, characteristics (e.g., oil pressure, oil level, tire pressure, fuel level, speed, etc.), etc.

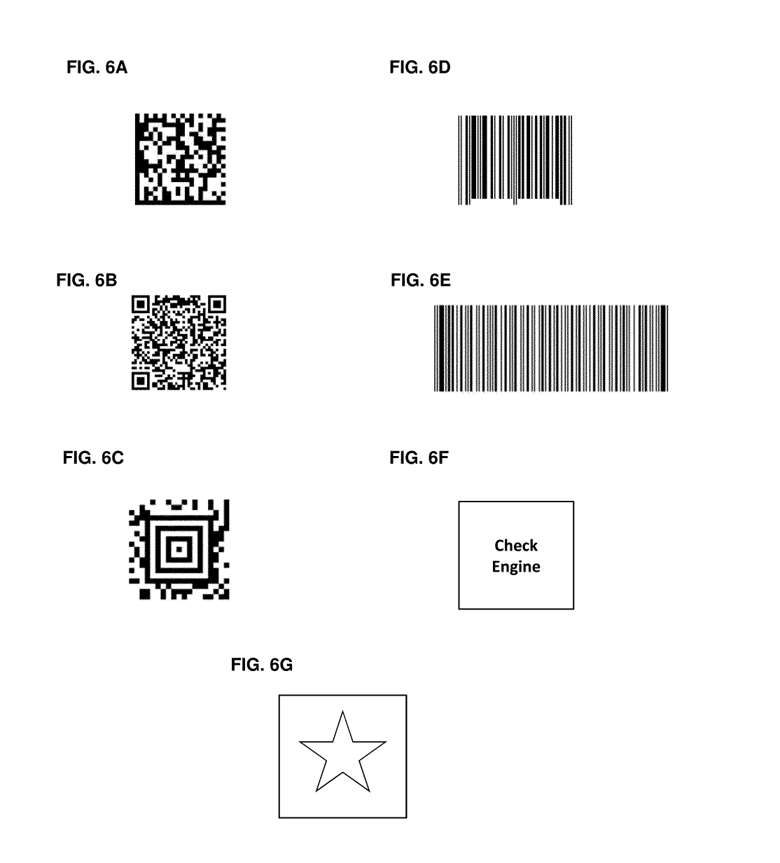

The images disclosed herein may be any suitable image. For example, the images may include barcodes such as 2D barcodes, linear barcodes, etc. The 2D barcodes may include, for example, a data matrix barcode (FIG. 6A), a Quick Response (QR) code (FIG. 6B), an Aztec code (FIG. 6C), etc. The linear barcodes may include, for example, a Universal Product Code (UPC) barcode (FIG. 6D), a Code 93 type barcode (FIG. 6E), etc.

In other exemplary embodiments, the images may include an image of text. For example, FIG. 6F illustrates an image including the text “Check Engine.” Additionally and alternatively, the image may include a particular symbol, design, configuration, etc. representing the collected data. For example, FIG. 6G illustrates an image of a star. The computer servers disclosed herein may decode the star to reveal the collected data as explained above.

Employing any one or all of the computer-implemented methods and/or systems disclosed herein may include one or more (but not necessary any or all) of the following various advantages. For example, by transmitting and/or receiving images representing collected data via MMS protocol, cellular data used to send and/or receive collected data may be reduced (and in some cases eliminated) as compared to sending the collected data in its original form, via Short Message Service (SMS) messages, etc. As a result, businesses, individuals, etc. may subscribe to, pay for, etc. cellular data plans including lower cellular data, which, in turn, may reduce costs.

Additionally, by employing the MMS protocol to send and/or receive images representing collected data, devices may send and/or receive more (if not all) of the collected data, etc. compared to other known approaches including, for example, SMS messages. For example, a SMS message may be limited to about 160 characters, whereas a MMS message is not limited to a specific character limit. Additionally, a MMS message may include images, music, animation, etc. and support a message having a size of about 300 kilobytes (kB) or more. In some embodiments, the size of the message may range up to about 600 kB.

The computer-implemented methods and/or systems may be employed in various applications. For example, the computer-implemented methods and/or systems may be employed in a fleet management system including various vehicles, a personal vehicle diagnostic system, etc.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method of transmitting data via a network from a client device in a vehicle to a computer server, the computer-implemented method comprising:
collecting data from one or more sensors in or about a vehicle;
generating an image representing the collected data; and
transmitting the image to a computer server via multimedia messaging service (MMS) protocol.

2. The computer-implemented method of claim 1, further comprising receiving a request for the data from the computer server via MMS protocol.

3. The computer-implemented method of claim 1, further comprising receiving a response from the computer server via MMS protocol in response to the transmitted image.

4. The computer-implemented method of claim 1, further comprising encrypting the data prior to generating the image.

5. The computer-implemented method of claim 1, wherein the image includes a barcode.

6. The computer-implemented method of claim 1, wherein collecting the data includes collecting the data in response to a defined event.

7. The computer-implemented method of claim 1, wherein generating the image includes generating the image in response to a defined event.

8. The computer-implemented method of claim 7, wherein the defined event includes a period of time.

9. A non-transitory computer readable medium storing computer-executable instructions for performing the method of claim 1.

10. A client device comprising a processor, memory, and computer-executable instructions stored in said memory and executable by the processor, the processor configured to perform the computer-implemented method of claim 1.

11. A computer-implemented method of receiving data from one or more client devices positioned in one or more vehicles, the computer-implemented method executed by one or more computer servers, the method comprising:
transmitting a request for data to a client device of the one or more client devices via MMS protocol;
receiving an image representing data collected by the client device via MMS protocol in response to the request; and
decoding the image to reveal the collected data.

12. The computer-implemented method of claim 11, wherein transmitting the request includes transmitting the request when the client device becomes available.

13. The computer-implemented method of claim 11, wherein the client device is a first client device and the image is a first image, the computer-implemented method further comprising transmitting a request to a second client device of the one or more client devices via MMS protocol and receiving a second image representing data collected by the second client device via MMS protocol in response to the request.

14. The computer-implemented method of claim 11, wherein transmitting the request includes transmitting the request in response to a defined event.

15. The computer-implemented method of claim 14, wherein the defined event includes a period of time.

16. The computer-implemented method of claim 14, further comprising transmitting a response to the client device via MMS protocol in response to the collected data.

17. The computer-implemented method of claim 16, wherein the image includes a barcode.

18. The computer-implemented method of claim 11, further comprising:
storing at least a portion of the collected data; and/or storing the image.

19. A non-transitory computer readable medium storing computer-executable instructions for performing the method of claim 11.

20. One or more computer servers comprising one or more processors, memory, and computer-executable instructions stored in said memory and executable by the one or more processor, the one or more processor configured to perform the computer-implemented method of claim 11.
